(19) United States
(12) Patent Application Publication
(10) Pub. No.: US 2009/0245506 A1
(43) Pub. Date: Oct. 1, 2009

(54) FOURIER SERIES BASED AUTHENTICATION/DERIVATION

(76) Inventors: Mathieu Ciet, Paris (FR); Augustin J. Farrugia, Cupertino, CA (US); Jean-Francois Riendeau, Santa Clara, CA (US); Nicholas Sullivan, Sunnyvale, CA (US)

Correspondence Address: APPLE C/O MOFO PALO ALTO, 755 PAGE MILL ROAD, PALO ALTO, CA, 94304-1018, US

(21) Appl. No.: 12/198,813

(22) Filed: Aug. 26, 2008

Related U.S. Application Data
(60) Provisional application No. 61/041,511, filed on Apr. 1, 2008.

(51) Int. Cl. H04L 9/28

(52) U.S. Cl. 380/28

(57) ABSTRACT

For purposes of cryptographic authentication, verification and digital signature processes, a derivation function is provided. The derivation function is generated from a Fourier series, using a prime number to compute the initial value in the series.

### CROSS REFERENCE TO RELATED APPLICATION

This application claims priority to U.S. provisional application No. 61/041,511 filed Apr. 1, 2008 incorporated herein by reference in its entirety.

### FIELD OF THE INVENTION

This invention relates to data security and cryptography.

### PRIOR ART

Authentication and verification are well known tasks in data security and typically employ cryptographic methods to authenticate and/or verify message content, passwords, user identification, digital signatures and other information. Many such authentication and verification techniques are known in the field.

### SUMMARY

This invention relates to data security and cryptography, and more specifically to computer enabled authentication and verification in cryptography. This disclosure is of a derivation function generated from a Fourier series that may be used for cryptographic authentication and verification and signature processes. This includes authentication or a keyed digest of a message of any length.

Also contemplated is a computer program to carry out the derivation function, a computer readable medium storing such a program coded, e.g., in the C++ computer language, and a programmed computing device programmed with the computer program, as well as an apparatus to carry out the function. Coding such a program would be routine in light of this disclosure.

### BRIEF DESCRIPTION OF THE FIGURE

FIG. 1 shows in a block diagram a method and associated apparatus in accordance with the invention.

### DETAILED DESCRIPTION

Cosh(x) is the well-known hyperbolic cosine function. This is conventionally defined as cosh(x)=(e^{x}+e^{-x})/2. Sinh is the well known hyperbolic sine function, defined as sinh(x)=(e^{x}−e^{-x})/2. The hyperbolic tangent function is cosh/sinh. Hyperbolic cosine and sine have similar sign properties as sine and cosine, so cosh(−x)=cosh x and sinh(−x)=−sinh(x). Also hyperbolic cosine and sine have a similar relationship when computing integrals as do cosine and sine. Also, cosh²(x)−sinh²(x)=1. The relations for (internal) addition and subtraction are also the same as for cosine and sine.

Given any integer a, a^{x}+a^{-x} equals β*cosh(α*x) for well-defined integers α and β. Similarly, a^{x}−a^{-x}=μ* cosh(λ*x) for well defined integers λ, μ. The following relations also hold: e^{x}=cosh x+sinh x, e^{-x}=cosh x−sinh x, also e^{ix}=cos x+i*sin x, and e^{-ix}=cos x−i*sin x.

In the physics field, there is another well-known function called the Fourier series used to analyze periodic functions in imaging and signal processing and defined as:

$$f ( x ) = {\sum }_{n = - ∞}^{+ ∞} {c}_{n} ( f ) {e}^{i2 π \frac{n}{T} x}$$

where the coefficients cₙ are expressed as:

$${c}_{n} ( f ) = \frac{1}{T} {\int }_{- T / 2}^{T / 2} f ( t ) {e}^{- i2 π \frac{n}{T} t} d t$$

The exponential with the complex variable i is expressed as the sum of the cosine and the sine of the given value, with the complex value on the sine side.

For purposes of cryptographic processes, in one embodiment consider only the cosine part of the exponential and use (for an exemplary implementation of an authentication or verification process) the hyperbolic cosine, but in other embodiments the sinh part is used, or both. In some computer enabled applications, operations on floating point (“floating”) numbers are not available. So here instead of using the cosine function, it is translated here to cosh. However, the present method is also operable with sine and cosine.

Instead of doing the operations over floating values, this is done over integers in one embodiment by introducing a prime number p with the following two properties defining a strong prime number:
1) p is a prime number
2) (p−1)/2 is a prime number

The method may be extended to other parameters where the second conditions on p is not satisfied, but that may degrade security. Instead of computing an infinite sum, one may compute an addition from i to 1(1 to be defined according to the performance required). Instead of computing coefficients cₙ, one may fix coefficients cₙ to any value (since p is prime). Also, one could use a given function f a priori, then compute the coefficients cₙ and use them. Alternatively, one could use a prime number p with q/(p−1)2 being large enough.

Then, given prime number p, and coefficients cᵢ, and an input (a “message” including a password, user identification, digital signature, communication or data including a random number expressed in numerical form) designated m, one computes f(m) (the present cryptographic function of m) as follows as expressed in pseudo-code form:

f(m) = 0;
Compute m⁻¹ modulus p =: mInv
for i from 2 to 1

f(m) + = cᵢ * (mⁱ + mInvⁱ) modulus p

Output f(m)

The initial value of f(m) may be other than zero. Note also the possibility of adding a modification on the above exponent by computing (on the update part of the computation) m^{r(i)}+mInv^{s(i)}; where r and s are small derivation functions (applying the function on i plus other values). A typical example is to take s=r, and s(j)=e*i+g modulus 8; where e is an odd integer whereas g may be any value. This way, there is no incremental update of the exponent, and moreover the exponents (intermediates) are bounded.

Note the above computation of mInv is always possible since p has been chosen to be a prime number. From a computational point of view, if value p is well-chosen, the Fermat theorem may be used to compute the inverse of m.

As an improvement, one could also apply to m (before its use in the derivation function f(m)) a bijective function, thereby permuting the elements of m.

If m is smaller (has fewer bits when expressed in binary form) than prime number p, then padding of m is needed so it has as many bits as does p.

As a simple extension, the update in the above computation of f(m) could be done using the original coefficients cₙ (which are derived from a given f(m) function).

Moreover, one may use a specific coefficient cᵢ to calculate the m part and another coefficient for the mInv calculation. Hence f(m) would be expressed as cᵢ0*mⁱ+cᵢ1*mInvⁱ mod p.

This derivation function can be used for an authentication process by using for m a random number and keeping the coefficients cᵢ, also (if used) the exponent derivation function, and (if used) the initial bijective function, and the prime number p (but not necessarily p) secret. Then authentication is accomplished if f(m) is equal on both sides. [what about verification?]

This derivation function can also be used as a message authentication code (MAC). Assume a message m of any size. This message m is first enlarged (if needed) to decompose it into a set of blocks of size a multiple of number p so m =m0 11 . . . 11 ml where “11” designates concatenation. For each mk (from 0 to 1), function f(mk) is computed and the digest is obtained by assembling the set of f(mk), k being a variable. This assembling operation can be done by using a conventional hash function of the result for security. Use of other assembling operations are also possible here.

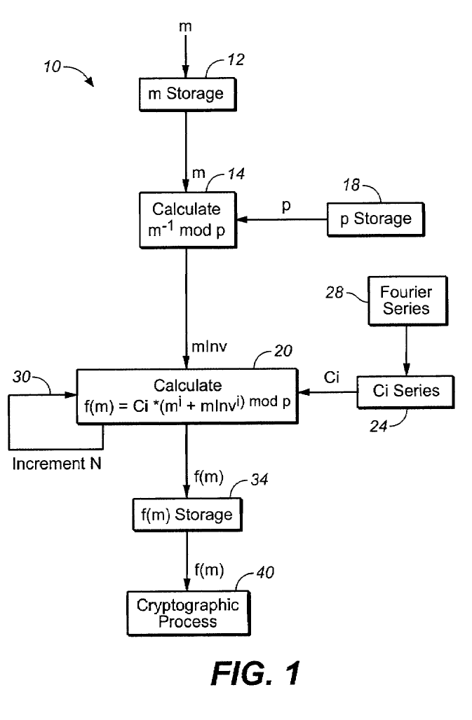

FIG. 1 illustrates in block diagram form operation of a computer program or apparatus 10, such as a programmed computer or computing device, to carry out the above method. Starting with numerical input message m, m is stored in a storage element 12, such as a register. Value m is supplied to a first calculation/computing element 14, the other input to which is number p from its storage element 18, and value mInv is calculated at 14 and input to the second calculation element 20, which is also supplied with coefficients cᵢ supplied from their storage element 24, and generated from a Fourier series generator 28. The calculated output of the second calculation element 20 is iterated at 30 over i which is incremented by 1 at each iteration, resulting in value f(m) which is then stored in an output storage element 34 and used in an otherwise conventional cryptographic process 40 as described above.

Coding such a computer program in a suitable computer language such as C++ would be routine in light of this disclosure. The computer program may be embodied in a computer readable storage medium in source code or coupled (object code) form. Alternatively, the FIG. 1 operation may be embodied in logic (hardware).

This disclosure is illustrative but not limiting; further modifications will be apparent to those skilled in the art in light of this disclosure and are intended to fall within the scope of the appended claims.

1. A computer enabled method of producing a cryptographic value from a value m, comprising the acts of:
providing a number p;
computing the value mInv=m⁻¹ modulus p;
computing a function f for i where f(m)=cᵢ (mⁱ+mInvⁱ) modulus p, where each coefficient cᵢ is generated from a Fourier series; and
using the computed value f(m) in a cryptographic process.

2. The method of claim 1, wherein the Fourier series is determined using at least one trigonometric function.

3. The method of claim 2, wherein the trigonometric function is a sine, cosine, hyperbolic sine, or hyperbolic cosine.

4. The method of claim 1, where p is a prime number and (p−1)/2 equals a prime number.

5. The method of claim 1, further comprising the act of:
applying a bijective function to value m prior to computing the value mInv.

6. The method of claim 1, further comprising the acts of:
determining if a length of value m is at least equal to a length of p; and
if the length of value m is not at least equal to the length of p, padding m to be at least the length of p.

7. The method of claim 1, wherein value m is a random or pseudo-random number.

8. The method of claim 1, wherein the cryptographic process is an authentication or verification.

9. The method of claim 8, wherein the cryptographic process is one of an authentication keyed digest calculation, digital signature authentication, or message authentication calculation.

10. The method of claim 1, wherein p is a floating point number.

11. The method of claim 1, further comprising setting an initial value for f(m).

12. The method of claim 1, further comprising the act of updating f(m).

13. The method of claim 1, wherein the value m is a message and the method authenticates message m, and further comprising the acts of:
partitioning message m into a plurality of portions of equal size;
computing f(m) for each portion; and
assembling the computed f(m) for each portion together to obtain a message digest.

14. The method of claim 1, wherein value m is one of a password, user identification, digital signature, communication, data, or random number.

15. The method of claim 1, wherein f(m)=cᵢ0 mⁱ+cᵢ1 mInv¹ modulus p.

16. The method of claim 1, further comprising repeating the acts of repeating the function f a predetermined number of time.

17. A computer readable medium storing computer code for performing the method of claim 1.

18. A computing apparatus programmed to perform the method of claim 1.

19. The medium of claim 13, wherein the code is coded in the C++ language.

20. Apparatus for producing a value for a cryptographic process, the apparatus comprising:
a first storage element for storing a value m;
a second storage element for storing a number p;
a first calculator element coupled to receive value m and number p and to compute the value mInv=m⁻¹ modulus p;
a third storage element to store coefficients cᵢ, and coupled to receive the coefficients cᵢ from a Fourier series generator;
a second calculator element coupled to receive mInv and coefficients cᵢ, and to compute a function f for i where f(m)=cᵢ*(mⁱ+mInvⁱ) modulus p; and
a fourth storage element coupled to receive the computed value f(m) from the second calculator element.
